(19) United States
(12) Patent Application Publication
(10) Pub. No.: US 2020/0380970 A1
(43) Pub. Date: Dec. 3, 2020

(54) METHOD AND APPARATUS FOR USER-DEFINED SCRIPT-BASED VOICE-COMMAND RECOGNITION

(71) Applicant: University of Malta, Msida (MT)

(72) Inventors: Jason GAUCI, Rabat (MT); Alan MUSCAT, Pembroke (MT); Kevin THEUMA, Attard (MT); David ZAMMIT-MANGION, Mellieha (MT); Matthew XUEREB, Mosta (MT)

(73) Assignees: University of Malta, Msida (MT); QUAERO LTD., Mosta (MT)

(21) Appl. No.: 16/429,484

(22) Filed: Jun. 3, 2019

(51) Int. Cl. G10L 15/22; B64C 19/00

(52) U.S. Cl. CPC G10L 15/22; G10L 2015/223; B64C 19/00

(57) ABSTRACT

A method of recognizing at least one avionics system command from a voice command includes receiving a plurality of voice command definitions, each voice command definition identifying at least one avionics system command and identifying at least one voice command template that is mapped to the at least one avionics system command; receiving the voice command as raw speech; generating recognized speech by converting the raw speech into text; determining a voice command template that corresponds to the recognized speech; selecting a voice command definition, from among the plurality of voice command definitions, that identifies the determined voice command template; determining, as the at least one recognized avionics system command, the at least one avionics system command identified by the selected voice command definition; and providing the at least one recognized avionics system command to a avionics system for execution.

### BACKGROUND

### 1. Field

Various example embodiments relate generally to methods and apparatuses for facilitating the recognition of voice commands from speech input.

### 2. Related Art

The use of voice to interact with electronic devices—such as smartphones and tablets—is on the rise. Voice offers several advantages over other modes of interaction such as touch. For instance, the user can operate the device hands-free without having to look directly at the device or navigate through complex menus. Some speech recognition systems are programmed to recognize any speech whereas others are programmed to recognize only a set of predefined voice commands. Furthermore, speech recognition systems may be either speaker-dependent (i.e., tuned to recognize a particular voice) or speaker-independent.

### SUMMARY

According to at least some example embodiments, a method of recognizing at least one avionics system command from a voice command comprises receiving a plurality of voice command definitions, each voice command definition identifying at least one avionics system command and identifying at least one voice command template that is mapped to the at least one avionics system command; receiving the voice command as raw speech; generating recognized speech by converting the raw speech into text; determining a voice command template that corresponds to the recognized speech; selecting a voice command definition, from among the plurality of voice command definitions, that identifies the determined voice command template; determining, as the at least one recognized avionics system command, the at least one avionics system command identified by the selected voice command definition; and providing the at least one recognized avionics system command to a avionics system for execution.

The method may further comprise determining whether the selected voice command definition includes a confirmation omission indicator; and in response to determining that the selected voice command definition does not include the confirmation omission indicator, performing a confirmation process, the confirmation process including, generating a confirmation request, receiving a response to the confirmation request, and postponing the providing of the at least one recognized avionics system command to the avionics system until after receiving the response to the confirmation request.

The method may further comprise determining whether the selected voice command definition includes a confirmation performance indicator; and in response to determining that the selected voice command definition includes the confirmation performance indicator, performing a confirmation process, the confirmation process including, generating a confirmation request, receiving a response to the confirmation request, and postponing the providing of the at least one recognized avionics system command to the avionics system until after receiving the response to the confirmation request.

The receiving of the plurality of voice command definitions may comprise receiving one or more script files; and reading the plurality of voice command definitions from the one or more script files.

The at least one avionics system command may be at least one command defined by a specification of the avionics system.

The method may further comprise executing, by the avionics system, the avionics system command.

The avionics system may be an avionics system of a flight simulator.

The avionics system may be an avionics system of an aircraft.

The plurality of voice command definitions may include a first voice command definition, the at least one voice command template identified by the first voice command definition may be a plurality of voice command templates, and the plurality of voice commands templates may be mapped, by the first voice command definition, to the at least one avionics system command identified by the first voice command definition such that, in response to any one of the plurality of voice command templates identified by the first voice command definition being determined to correspond to the recognized speech, the at least one avionics system command identified by the first voice command definition is provided to the avionics system as the at least one recognized avionics system command.

The plurality of voice command definitions may include a first voice command definition, the at least one avionics system command identified by the first voice command definition may be a plurality of avionics system commands, and the at least one voice command template identified by the first voice command definition may be mapped, by the first voice command definition, to the plurality of avionics system commands such that, in response to the at least one voice command template identified by the first voice command definition being determined to correspond to the recognized speech, the plurality of avionics system commands are provided to the avionics system as the at least one recognized avionics system command.

According to at least some example embodiments, an apparatus for recognizing at least one avionics system command from a voice command comprises memory storing computer-executable instructions; and one or more processors configured to execute the computer-executable instructions such that the one or more processors are configured to perform operations including, receiving a plurality of voice command definitions, each voice command definition identifying at least one avionics system command and identifying at least one voice command template that is mapped to the at least one avionics system command, receiving the voice command as raw speech, generating recognized speech by converting the raw speech into text, determining a voice command template that corresponds to the recognized speech, selecting a voice command definition, from among the plurality of voice command definitions, that identifies the determined voice command template, determining, as the at least one recognized avionics system command, the at least one avionics system command identified by the selected voice command definition, and providing the at least one recognized avionics system command to a avionics system for execution.

The one or more processors may be further configured to execute the computer-executable instructions such that the one or more processors are configured to determine whether the selected voice command definition includes a confirmation omission indicator, and in response to determining that the selected voice command definition does not include the confirmation omission indicator, perform a confirmation process, the confirmation process including, generating a confirmation request, receiving a response to the confirmation request, and postponing the providing of the at least one recognized avionics system command to the avionics system until after receiving the response to the confirmation request.

The one or more processors may be further configured to execute the computer-executable instructions such that the one or more processors are configured to determine whether the selected voice command definition includes a confirmation performance indicator; and in response to determining that the selected voice command definition includes the confirmation performance indicator, perform a confirmation process, the confirmation process including, generating a confirmation request, receiving a response to the confirmation request, and postponing the providing of the at least one recognized avionics system command to the avionics system until after receiving the response to the confirmation request.

The one or more processors may be further configured to execute the computer-executable instructions such that the receiving of the plurality of voice command definitions includes receiving one or more script files; and reading the plurality of voice command definitions from the one or more script files.

The one or more processors may be further configured to execute the computer-executable instructions such that the at least one avionics system command is at least one command defined by a specification of the avionics system.

The one or more processors may be further configured to execute the computer-executable instructions such that the one or more processors are configured to cause the avionics system to execute the avionics system command.

The avionics system may be an avionics system of a flight simulator.

The avionics system may be an avionics system of an aircraft.

The one or more processors may be further configured to execute the computer-executable instructions such that the plurality of voice command definitions includes a first voice command definition, the at least one voice command template identified by the first voice command definition is a plurality of voice command templates, and the plurality of voice commands templates are mapped, by the first voice command definition, to the at least one avionics system command identified by the first voice command definition such that, in response to the one or more processors determining that any one of the plurality of voice command templates identified by the first voice command definition to corresponds to the recognized speech, the one or more processors provide the at least one avionics system command identified by the first voice command definition to the avionics system as the at least one recognized avionics system command.

The one or more processors may be further configured to execute the computer-executable instructions such that the plurality of voice command definitions includes a first voice command definition, the at least one avionics system command identified by the first voice command definition is a plurality of avionics system commands, and the at least one voice command template identified by the first voice command definition is mapped, by the first voice command definition, to the plurality of avionics system commands such that, in response to the one or more processors determining that the at least one voice command template identified by the first voice command definition corresponds to the recognized speech, the one or more processors provide the plurality of avionics system commands to the avionics system as the at least one recognized avionics system command.

### BRIEF DESCRIPTION OF THE DRAWINGS

At least some example embodiments will become more fully understood from the detailed description provided below and the accompanying drawings, wherein like elements are represented by like reference numerals, which are given by way of illustration only and thus are not limiting of example embodiments and wherein:

FIG. 1 is a diagram of a voice-command recognition system according to at least some example embodiments.

FIG. 2 is a diagram illustrating an example structure of a system element according to at least some example embodiments.

FIG. 3A illustrates an example of a voice command definition corresponding to a command to switch on a first autopilot.

FIG. 3B illustrates an example of a voice command definition corresponding to an absolute target heading setting command.

FIG. 3C illustrates an example of a voice command definition corresponding to a target altitude setting command.

FIG. 3D illustrates an example of a voice command definition corresponding to a command to level off and maintain a current speed, heading and altitude.

FIG. 3E illustrates an example of a voice command definition corresponding to a command to set an aircraft altitude to a current altitude.

FIG. 3F illustrates an example of a voice command definition corresponding to a command to set a target airspeed.

FIG. 3G illustrates an example of a voice command definition corresponding to a command to zoom a navigation display in or out.

FIG. 4 is a flow chart illustrating an example method of operating the voice-command recognition system of FIG. 1 to perform user-defined script-based voice-command recognition according to at least some example embodiments.

FIG. 5 is a flow chart illustrating an example initialization method of a voice-command recognition system according to at least some example embodiments.

FIG. 6 illustrates an example of voice command definition tokenization.

FIGS. 7A and 7B are figures for facilitating the explanation of example methods of handling variables in voice command templates according to at least some example embodiments.

### DETAILED DESCRIPTION OF EXAMPLE EMBODIMENTS

Various example embodiments will now be described more fully with reference to the accompanying drawings in which some example embodiments are shown.

Detailed illustrative embodiments are disclosed herein. However, specific structural and functional details disclosed herein are merely representative for purposes of describing at least some example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but on the contrary, example embodiments are to cover all modifications, equivalents, and alternatives falling within the scope of example embodiments. Like numbers refer to like elements throughout the description of the figures. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Exemplary embodiments are discussed herein as being implemented in a suitable computing environment. Although not required, exemplary embodiments will be described in the general context of computer-executable instructions (e.g., program code), such as program modules or functional processes, being executed by one or more computer processors or CPUs. Generally, program modules or functional processes include routines, programs, objects, components, data structures, etc. that performs particular tasks or implement particular abstract data types.

In the following description, illustrative embodiments will be described with reference to acts and symbolic representations of operations (e.g., in the form of flowcharts) that are performed by one or more processors, unless indicated otherwise. As such, it will be understood that such acts and operations, which are at times referred to as being computer-executed, include the manipulation by the processor of electrical signals representing data in a structured form. This manipulation transforms the data or maintains it at locations in the memory system of the computer, which reconfigures or otherwise alters the operation of the computer in a manner well understood by those skilled in the art.

As is discussed in greater detail below, a user-defined script-based voice-command recognition method according to at least some example embodiments allows users of, for example, a voice-command recognition system that recognizes avionics system commands from input speech to utilize user-defined scripts in order to control the manner in which the voice-command recognition system translates input speech into avionics system commands (i.e., a command defined by a specification of an avionics system). Thus, according to at least some example embodiments, a user can fix or improve the manner in which the voice-command recognition system translates speech into an avionics system command without the need for the user to access and reprogram underlying program code of the avionics system or a speech-to-text conversion function of the voice-command recognition system.

The term “avionics system,” as used in the present specification, may refer to one or more of an avionics system of a flight simulation system, an avionics system of a physical aircraft, or any other known avionics system. Examples of a physical aircraft include, but are not limited to, an airplane.

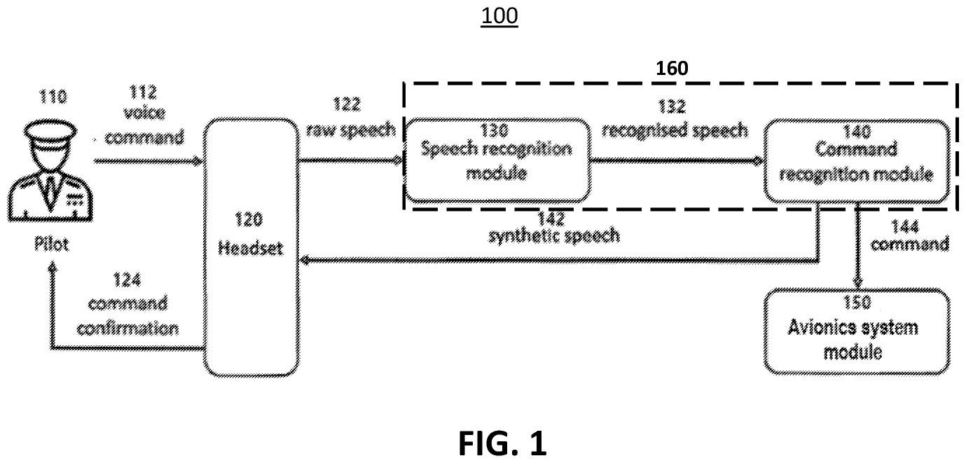

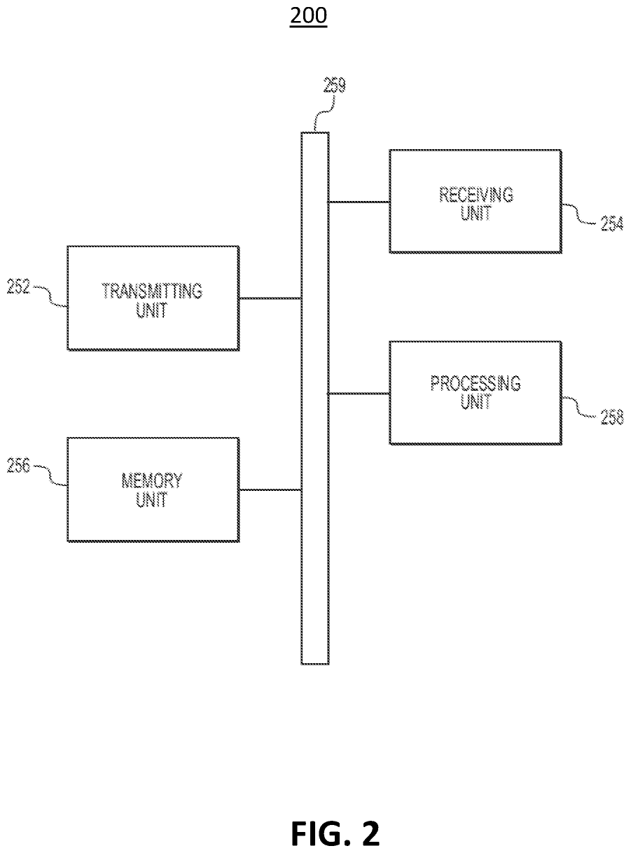

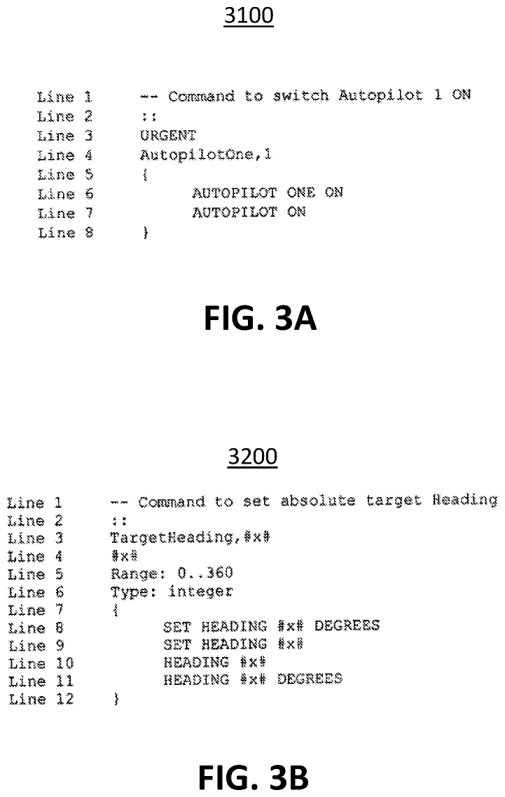

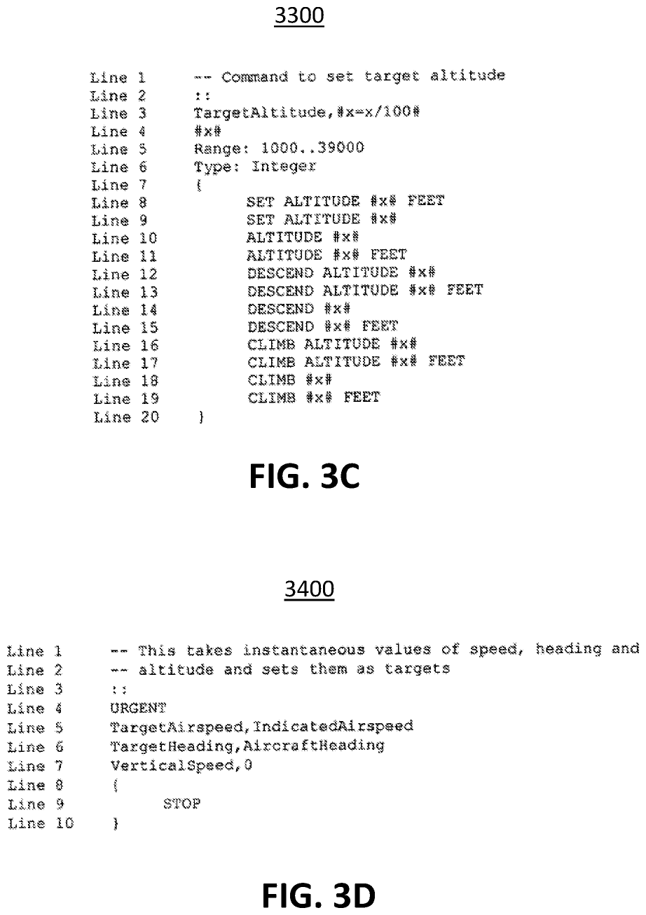

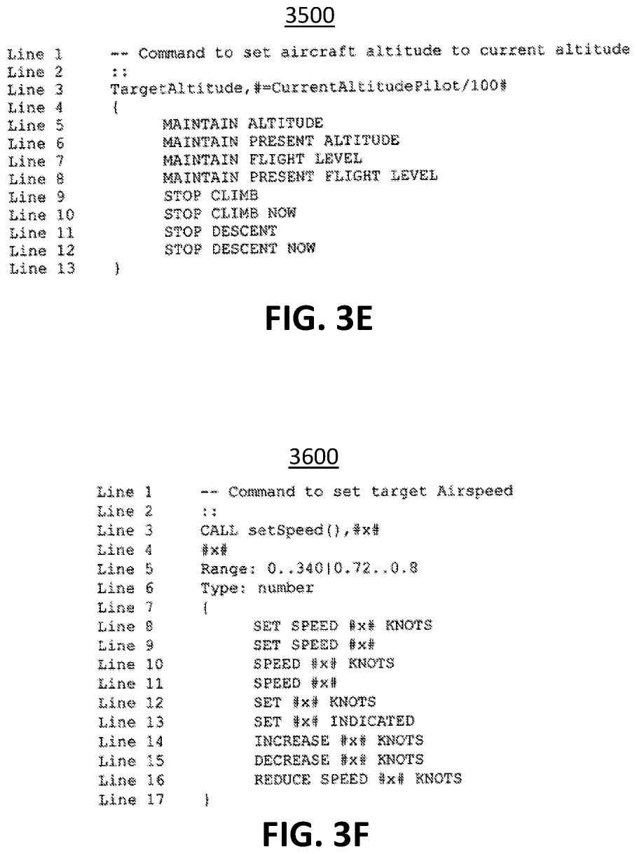

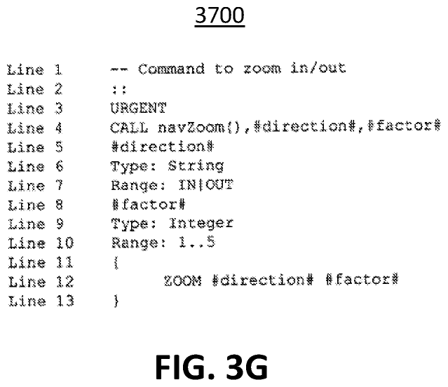

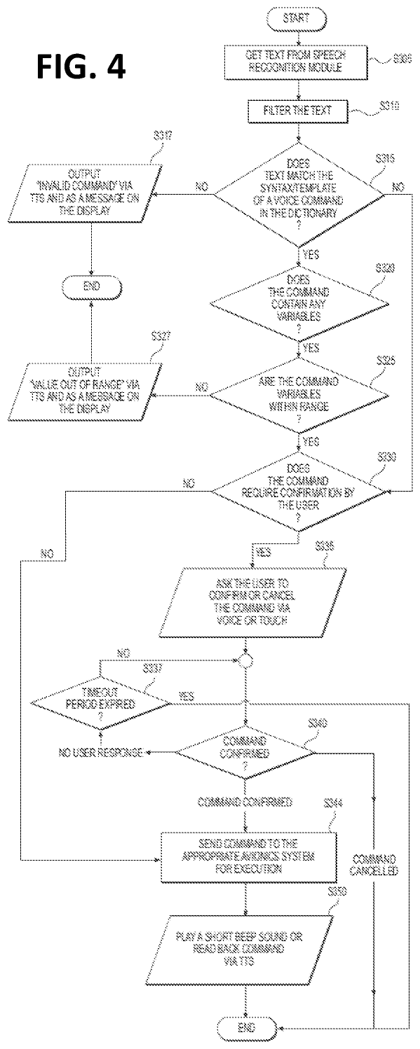

An example architecture of a voice-command recognition system 100 which may utilize the user-defined script-based voice-command recognition method according to at least some example embodiments is described below with reference to FIGS. 1 and 2 of the present specification. Examples of voice command definitions, which are user-defined script that can be used with the user-defined script-based voice-command recognition method according to at least some example embodiments, are described below with reference to FIGS. 3A-3G. An example method of operating the voice-command recognition system 100 to perform user-defined script-based voice-command recognition according to at least some example embodiments is described below with reference to FIG. 4.

FIG. 1 is a diagram of a voice-command recognition system 100 according to at least some example embodiments. Referring to FIG. 1, the voice-command recognition system 100 may include a voice-command translation apparatus 160 and an avionics system module 150. The voice-command translation apparatus 160 may include a speech recognition module 130 and a command recognition module 140.

The speech recognition module 130 performs a speech-to-text function. For example, the speech recognition module 130 may receive raw speech 122, recognize words within the raw speech 122, and output the words, in the form of text, as recognized speech 132. According to at least some example embodiments, the speech recognition module may be implemented, for example, by Google Assistant or any other known application capable of performing a speech-to-text conversion function.

The command recognition module 140 attempts to recognize one of a plurality of avionics system commands defined by a specification of the avionics system module 150 as corresponding to the text of the recognized speech 132. As will be discussed in greater detail below with reference to FIG. 4, if the command recognition module 140 succeeds in recognizing an avionics system command 144 corresponding to the recognized speech 132, the command recognition module 140 determines whether or not to perform a confirmation process. In response to determining not to perform the confirmation process, or performing the confirmation process and receiving confirmation from the pilot 110, the command recognition module 140 provides the avionics system command 144 to the avionics system module 150 for execution.

For example, according to at least some example embodiments, the confirmation process includes the command recognition module 140 generating an audible request for confirmation of one or more recognized avionics system commands in the form of synthetic speech 142; sending the synthetic speech 142 to headset 120, which provides the confirmation request to the pilot 110 as command confirmation 124; and postponing the provision of the avionics system command 144 to the avionics system module 150 for execution until receiving an indication that the pilot 110 has confirmed the avionics system command 144. According to at least some example embodiments, if the command recognition module 140 does not receive confirmation of the avionics system command 144 from the pilot 110 within a reference amount of time, or the pilot 110 responds to the confirmation request with a cancellation request, the command recognition module 140 cancels the avionics system command 144. According to at least some example embodiments, when the command recognition module 140 cancels the avionics system command 144, the command recognition module 140 stops awaiting confirmation of the avionics system command 144 from the pilot 110, and does not send the avionics system command 144 to the avionics system module 150.

According to at least some example embodiments, the avionics system module 150 may be embodied by an avionics system of flight simulation system (e.g., flight simulator software). Examples of flight simulation systems which may be used to implement the avionics system module 150 include, but are not limited to, X-plane and FlightGear. When the avionics system module 150 is embodied by a flight simulation system, the avionics system command 144 may be, for example, one of a plurality of commands included in a command set defined by a specification of the flight simulation system.

According to at least some other example embodiments, the avionics system module 150 may be embodied by an avionics system of a physical aircraft or an interface through which an avionics system of a physical aircraft can receive commands. When the avionics system module 150 is embodied by an avionics system of a physical aircraft, or an interface through which an avionics system of a physical aircraft can receive commands, the avionics system command 144 may be, for example, one of a plurality of commands included in a command set defined by a specification of the avionics system of a physical aircraft.

As will be discussed in greater detail below with reference to FIG. 3, one or more user-defined script files form some or all of a dictionary which the command recognition module 140 uses to recognize commands from text within the recognized speech 132. Further, the user-defined scripts may include an indicator which the command recognition module 140 uses to determine whether or not to perform the confirmation process before providing the avionics system command 144 to the avionics system module 150.

According to at least some example embodiments, the voice-command recognition system 100 may further include the headset 120. The headset 120 may include, for example, one or more speakers/headphones for outputting sound, and one or more microphones for receiving sound. For example, as is illustrated in FIG. 1, a pilot 110 may provide a voice command 112 to the voice-command recognition system 100 as audible speech via a microphone of the headset 120 (e.g., by speaking into the microphone), and may receive the command confirmation 124 as sound via speakers/headphones of the headset 120.

According to at least some example embodiments, the voice-command recognition system 100 may further include a display device (not illustrated). The display device may be any device capable of providing information to the pilot 110 in a visual manner (e.g., a terminal, a tablet, a liquid crystal display (LCD) panel, a heads-up display (HUD), a head-mounted display (HMD), etc.). The display device may display text corresponding to operations of the voice-command recognition system 100. For example, the display device may display text corresponding to one or more of the recognized speech 132, the avionics system command 144, and the command confirmation 124.

According to at least some example embodiments, the headset 120 and/or display device are connected to the voice-command translation apparatus 160 through wired and/or wireless connections in accordance with known methods.

According to at least some example embodiments, the voice-command recognition system 100 (e.g., the voice-command translation apparatus 160 and avionics system module 150) may be embodied, together, by the system element 200 illustrated in FIG. 2. Alternatively, according to at least some example embodiments, each of the speech recognition module 130, command recognition module 140, and avionics system module 150 may be separately embodied by elements each having the structure of the system element 200 illustrated in FIG. 2.

As another alternative, according to at least some example embodiments, the voice-command translation apparatus 160 (i.e., the speech recognition module 130 and command recognition module 140) may be embodied by an element having the structure of the system element 200 illustrated in FIG. 2, and the avionics system module 150 may be embodied by a separate element (or separate elements) having the structure of the system element 200 illustrated in FIG. 2.

For example, according to at least some example embodiments, the avionics system module 150 is embodied by an element having the structure of the system element 200, and is an interface between (A) a version of the system element 200 that embodies the voice-command translation apparatus 160 and (B) a plurality of different known avionics systems (e.g., autopilot, navigation system, communication system, etc). For example, the avionics system module 150 may be configured to provide the avionics system command 144 generated by the command recognition module 140 to the proper avionics system(s) from among a plurality of avionics systems.

As yet another example, according to at least another example embodiments, the avionics system module 150 may, itself, include a plurality of different known avionics systems (e.g., autopilot, navigation system, communication system, etc.) distributed amongst different processors (e.g., different instances of the system element 200), and the voice-command translation apparatus 160 may be configured to provide the avionics system command 144 to the proper avionics system(s) within the avionics system module 150. The system element 200 will now be discussed in greater detail below with reference to FIG. 2.

FIG. 2 is a diagram illustrating an example structure of the system element 200 according to at least some example embodiments.

Referring to FIG. 2, the system element 200 may include, for example, a data bus 259, a transmitting unit 252, a receiving unit 254, a memory unit 256, and a processing unit 258.

The transmitting unit 252, receiving unit 254, memory unit 256, and processing unit 258 may send data to and/or receive data from one another using the data bus 259.

The transmitting unit 252 is a device that includes hardware and any necessary software for transmitting signals including, for example, control signals or data signals via one or more wired and/or wireless connections to one or more other network elements in a wired and/or wireless communications network.

The receiving unit 254 is a device that includes hardware and any necessary software for receiving wired and/or wireless signals including, for example, control signals or data signals via one or more wired and/or wireless connections to one or more other network elements in a wired and/or wireless communications network.

The memory unit 256 may be any device capable of storing data including magnetic storage, flash storage, etc. Further, though not illustrated, the memory unit 256 may further include one or more of a port, dock, drive (e.g., optical drive), or opening for receiving and/or mounting removable storage media (e.g., one or more of a USB flash drive, an SD card, an embedded MultiMediaCard (eMMC), a CD, a DVD, and a Blue-ray disc).

The processing unit 258 may be any device capable of processing data including, for example, a processor.

According to at least one example embodiment, any operations described in the present specification as being performed by the voice-command recognition system 100, or an element thereof (e.g., the speech recognition module 130, command recognition module 140, and/or avionics system module 150), may be performed and/or controlled by an electronic device having the structure of the system element 200 illustrated in FIG. 2. For example, according to at least one example embodiment, the system element 200 may be programmed, in terms of software and/or hardware, to perform or control any or all of the functions described in the present specification as being performed by a voice-command recognition system, a voice-command translation apparatus, speech recognition module, command recognition module, and/or avionics system module. Consequently, the system element 200 may be embodied as a special purpose computer through software and/or hardware programming.

Examples of the system element 200 being programmed, in terms of software, to perform or control any or all of the functions described herein as being performed by a voice-command recognition system or element thereof will now be discussed below. For example, the memory unit 256 may store a program that includes computer-executable instructions (e.g., program code) corresponding to any or all of the operations described herein as being performed by a voice-command recognition system or element thereof. According to at least one example embodiment, additionally or alternatively to being stored in the memory unit 256, the computer-executable instructions (e.g., program code) may be stored in a computer-readable medium including, for example, an optical disc, flash drive, SD card, etc., and the system element 200 may include hardware for reading data stored on the computer readable-medium. Further, the processing unit 258 may be a processor configured to perform or control any or all of the operations described in the present specification as being performed by a voice-command recognition system or element thereof, for example, by reading and executing the computer-executable instructions (e.g., program code) stored in at least one of the memory unit 256 and a computer readable storage medium loaded into hardware included in the system element 200 for reading computer-readable mediums.

Examples of the system element 200 being programmed, in terms of hardware, to perform or control any or all of the functions described herein as being performed by a voice-command recognition system or an element thereof will now be discussed below. In addition, or as an alternative, to computer-executable instructions (e.g., program code) corresponding to the functions described in the present specification as being performed by a voice-command recognition system or element thereof being stored in a memory unit or a computer-readable medium as is discussed above, the processing unit 258 may include a circuit (e.g., an integrated circuit) that has a structural design dedicated to performing or controlling any or all of the operations described in the present specification as being performed by a voice-command recognition system or element thereof. For example, the above-referenced circuit included in the processing unit 258 may be a FPGA or ASIC physically programmed, through specific circuit design, to perform or control any or all of the operations described in the present specification as being performed by a voice-command recognition system or element thereof.

Examples of user-defined scripts that may be used with the voice-command recognition system 100 will now be discussed below with reference to FIGS. 3A-3G.

FIGS. 3A-3G illustrate various examples of voice command definitions that may be included in one or more script files which the command recognition module 140 may use to determine, based on recognized speech 132, corresponding avionics system commands from among a command set of the avionics system module 150. According to at least some examples embodiments, a voice command definition may include one or more voice command templates and one or more avionics system commands, and, for each voice command definition, the voice command definition maps the included one or more voice command templates to the included one or more avionics system commands. For example, as will be discussed in greater detail below with reference to FIGS. 3A-4, in response to determining that the text of the recognized speech 132 matches a voice command template included in a particular voice command definition, the command recognition module 140 determines the avionics system command(s) identified by that same particular voice command definition (i.e., the avionics system command(s) to which the matching voice command template is mapped) to be the recognized avionics system command(s).

Further, according to at least some example embodiments, a user-defined script file may include one or more voice command definitions. Additionally, a dictionary that the voice-command recognition system 100 uses to recognize avionics system commands from recognized speech 132 may be based on, or composed of (in whole or in part), the voice command definitions of one or more user-defined script files which are read by the voice-command recognition system 100 upon initialization of the voice-command recognition system 100. The voice commands illustrated in FIGS. 3A-3G are examples of user-defined scripts that may be included in one or more user-defined script files. Further, FIGS. 3A-3G provide examples of a format or formats that a voice command definition in a user-defined script file may follow, according to at least some example embodiments. According to at least some example embodiments, a user-defined script file may be a script file that is created by a user (e.g., the pilot 110) or script file that is capable of being modified by a user.

FIG. 3A illustrates an example of a voice command definition corresponding to a command to switch on a first autopilot. Referring to FIG. 3A, a first voice command definition 3100 may include multiple lines. Some of the lines include expressions (e.g., “--” or “::”) which the command recognition module 140 uses during a tokenization process.

For example, according to at least some example embodiments, the command recognition module 140 performs a tokenization process on user-defined scripts upon initialization of the voice-command recognition system 100. The tokenization process may include, for example, identifying each voice command definition in each user-defined script file; identifying features of each voice command definition (e.g., voice command templates, keywords, variables, variable constraints, etc.); and saving information corresponding to each voice command definition and the features of each voice command definition in memory of the voice-command recognition system 100 (e.g., the memory unit 256).

Expressions “--” and “::” will now be discussed in greater detail with reference to the first voice command definition 3100. According to at least some example embodiments, the characters “--,” as shown at line 1 of the first voice command definition 3100, may precede text that is intended to be a comment. A comment is, for example, information that can be useful for a user to read. For example, the comment in line 1 of the first voice command definition 3100 explains that the first voice command definition 3100 corresponds to a command for switching autopilot 1 ON. According to at least some example embodiments, the command recognition module 140 ignores text following the characters “--” on a line of a voice command definition when processing (e.g., tokenizing) the voice command definition. Further, the first voice command definition 3100 includes the characters “::” at line 2. According to at least some example embodiments, the command recognition module 140 uses the characters “::” during a tokenization process in order to identify the separations between contiguous voice command definitions when multiple voice command definitions are included in the same user-defined script file.

Line 3 of the first voice command definition 3100 includes the term “URGENT.” The term “URGENT” is an example of a confirmation omission indicator. According to at least some example embodiments, upon initialization of the voice-command recognition system 100 during the tokenization process discussed above, the command recognition module 140 identifies confirmation omission indicators within voice command definitions and the command recognition module 140 saves information indicating which voice command definitions include a confirmation omission indicator in memory of the voice-command recognition system 100. According to at least some example embodiments, the command recognition module 140 interprets the presence of a confirmation omission indicator (e.g., “URGENT”) within a voice command definition as an indication to omit the confirmation process. As used in the present specification, omitting the confirmation process (or, simply, omitting confirmation) refers to a process in which the command recognition module 140 provides the avionics system command identified by a voice command definition to the avionics system module 150 for execution, without first performing the confirmation process discussed above with reference to FIG. 1. As is discussed above with reference to FIG. 1, the confirmation process may include the command recognition module 140 generating an audible request for confirmation of one or more recognized avionics system commands in the form of synthetic speech 142; sending the synthetic speech 142 to headset 120, which provides the confirmation request to the pilot 110 as command confirmation 124; and postponing the provision of the avionics system command 144 to the avionics system module 150 for execution until receiving an indication that the pilot 110 has confirmed the avionics system command 144, or canceling the avionics system command 144 if confirmation is not received from the pilot 110 within a reference amount of time or if the pilot 110 responds to the confirmation request with a cancellation request.

According to at least some example embodiments, it is not necessary for a confirmation omission indicator (e.g., URGENT) to be spoken by a user (i.e., included in the voice command 112) in order for the voice-command recognition system 100 to omit the confirmation process. Rather, according to at least some example embodiments, the confirmation omission indicator (e.g., URGENT) need only be included in the voice command definition.

Returning to FIG. 3A, as is shown by line 4 of the first voice command definition 3100, the avionics system command identified by the first voice command definition 3100 is “AutopilotOne,1,” which is a command for instructing the avionics system module 150 to set a value of a first autopilot (i.e., AutopilotOne) to ON (i.e., the value 1).

As is known, commercial aircraft, for example, may have multiple (e.g., two) autopilots. Thus, though FIG. 3A illustrates an example of a voice command definition that is associated with a command that is directed to a first autopilot, example embodiments are not limited to the example illustrated in FIG. 3A. For example, a voice command definition according to at least some example embodiments can be associated with a command that is directed to one or more of a plurality of autopilots of an aircraft or simulation that has multiple autopilots.

Returning to line 4 illustrated in FIG. 3A, according to at least some example embodiments, when a voice command definition includes an avionics system command followed by a comma (i.e., “,”), the value, term or expression following the comma may refer to an argument of the avionics system command. Consequently, “AutopilotOne,1,” may refer to the command “AutopilotOne” with the argument “1.” According to at least some example embodiments, upon initialization of the voice-command recognition system 100 during the tokenization process discussed above, the command recognition module 140 identifies avionics system commands and corresponding arguments within voice command definitions, and the command recognition module 140 saves information indicating the avionics system commands and corresponding arguments of each voice command definition including the same in memory of the voice-command recognition system 100.

Accordingly, because the first voice command definition 3100 includes the term “URGENT,” the command recognition module 140 will omit confirmation. For example, the command recognition module 140 will provide the command “Autopilot,1” to the avionics system module 150 without first completing the confirmation process, in response to the command recognition module 140 determining that the recognized speech 132 corresponds to the first voice command definition 3100.

Further, for the purpose of simplicity, with respect to an example of a confirmation omission indicator, the present specification refers, primarily, to the term “URGENT.” However, according to at least some example embodiments, a confirmation indicator can be any term, phrase, symbol, or alphanumeric expression (e.g., “NOCONF,” “NO_CONF,” “!CONF,” “CONF_0,” “EXPEDITE,” “BYPASS,” etc.), and may be set in accordance with the preferences of a designer or operator of the voice-command recognition system 100 or command recognition module 140. For example, according to at least some example embodiments, an operator of the voice-command recognition system 100 may define the one or more terms that are to be recognized by the command recognition module 140 as confirmation omission indicators by listing the one or more terms in a user-defined confirmation omission indicator configuration file. Further, the voice-command recognition system 100 may read the user-defined confirmation omission indicator configuration file during the initialization of the voice-command recognition system 100. Further, according to at least some example embodiments, the command recognition module 140 may recognize more than one term, phrase, symbol, or alphanumeric expression at a time as a confirmation omission indicator. For example, the voice-command recognition system 100 or command recognition module 140 may be configured to recognize two different terms as confirmation omission indicators. As an example, if the command recognition module 140 is configured to recognize both of the terms “URGENT” and “NO_CONF” as confirmation omission indicators, the command recognition module 140 may omit the confirmation process with respect to an avionics system command identified in a voice command definition in response to determining that the voice command definition includes at least one of the terms “URGENT” and “NO_CONF.”

Further, as is noted above, it is not necessary for a confirmation omission indicator (e.g., URGENT or NO_CONF) to be spoken by a user (i.e., included in the voice command 112) in order for the voice-command recognition system 100 to omit the confirmation process. To the contrary, the portion of a voice command definition that defines which spoken words/phrases are to be recognized from the recognized speech 132 as corresponding to an avionics system command is the voice command template section. Further, according to at least some example embodiments, within a voice command definition, confirmation omission indicators are separate from the voice command template section. An example of the voice command template section will now be discussed below with reference to lines 5-8 of the first voice command definition 3100.

As is illustrated by FIG. 3A, lines 5-8 of the first voice command definition 3100 provide the voice command templates of the first voice command definition 3100. For example, lines 5 and 8 include the open and closed brackets “{” and “}” which indicate boundaries (e.g., a start point and end point), of a voice command template section of the first voice command definition 3100.

According to at least some example embodiments, the voice command template section of a voice command definition identifies the voice command templates that are mapped to the one or more avionics system commands identified by the voice command definition. For example, the voice command template section of a voice command definition identifies the terms and/or phrases which the command recognition module 140 is to translate into the one or more avionics system commands identified by the voice command definition. Thus, referring to FIG. 3A, the voice command template section of the first voice command definition 3100 includes voice command templates at lines 6 and 7. Line 6 includes the voice command template “AUTOPILOT ONE ON,” and line 7 includes the voice command template “AUTOPILOT ON.”

Consequently, referring to FIG. 3A and the voice-command recognition system 100 of FIG. 1, in response to the command recognition module 140 determining that text included in the recognized speech 132 corresponds to one of the voice command templates included in the voice command template section of the first voice command definition 3100, the command recognition module 140 will determine, as the avionics system command 144 that corresponds to the recognized speech 132, the avionics system command identified by the first voice command definition 3100 (i.e., “Autopilot,1”).

According to at least some example embodiments, the command recognition module 140 will determine that text included in the recognized speech 132 corresponds to a voice command template included in the voice command template section of a voice command definition when the text of the recognized speech 132 (excluding variables) matches the text of the voice command template (excluding variables). According to at least some example embodiments, upon initialization of the voice-command recognition system 100 during the tokenization process discussed above, the command recognition module 140 identifies voice command templates within voice command definitions, and the command recognition module 140 saves information indicating which voice command templates are included in each voice command definition in memory of the voice-command recognition system 100.

Accordingly, the manner in which the command recognition module 140 translates the recognized speech 132 into the avionics system command 144 is based on the contents of one or more voice command definitions included in one or more user-defined script files. Consequently, by changing the contents of the voice command template section of one or more voice command definitions in a user-defined script file (e.g., using a text editor), a user can easily control the manner in which the command recognition module 140 recognizes, from the recognized speech 132, the one or more avionics system commands 144 that are to be executed by the avionics system module 150. Further, as is shown by FIG. 3A, while the first voice command definition 3100 includes the confirmation omission indicator “URGENT” at line 3, the voice command templates at lines 6 and 7 do not include the term “URGENT.” Thus, in response to detecting, within the recognized speech 132, the phrase “AUTOPILOT ONE ON” or “AUTOPILOT ON,” the command recognition module 140 will omit confirmation with respect to the avionics system command (i.e., “Autopilot,1”) defined by the first voice command definition 3100, even if the recognized speech 132 does not include the term “URGENT.”

Further examples of voice command definitions will now be discussed with reference to FIGS. 3B-3G. In the discussions of FIGS. 3B-3G, duplicate explanations of some previously described elements are omitted.

FIG. 3B illustrates an example of a voice command definition corresponding to an absolute target heading setting command. Referring to FIG. 3B, a second voice command definition 3200 corresponds to an avionics system command that accepts a variable (e.g., as an argument). For example, line 3 of the second voice command definition 3200 includes “TargetHeading, #x #.” As is noted above with reference to FIG. 3A, according to at least some example embodiments, when a voice command definition includes an avionics system command followed by a comma (i.e., “,”), the value, term or expression following the comma may refer to an argument of the avionics system command. Further, according to at least some example embodiments, the command recognition module 140 interprets a term or value enclosed by two instances of the character “#” as a variable. Accordingly, the command recognition module 140 interprets the expression “#x #” as referring to a variable “x.” Consequently, the command recognition module 140 interprets “TargetHeading, #x #” at line 3 of the second voice command definition 3200 as identifying the avionics system command “TargetHeading” including the variable “x” as an argument.

According to at least some example embodiments, a voice command definition may define attributes and/or constraints for variables included in the voice command definition. For example, referring to lines 4-6 of the second voice command definition 3200, for the variable “x” (as indicated by line 4), a range of the variable is 0-360 (as indicated by line 5) and a type of the variable is “integer” (as indicated by line 6).

According to at least some example embodiments, upon initialization of the voice-command recognition system 100 during the tokenization process discussed above with reference to FIG. 3A, the command recognition module 140 identifies variable names and variable attributes and/or constraints (e.g., range, type, etc.) within voice command definitions, and the command recognition module 140 saves information indicating the variable names and variable attributes and/or constraints of each voice command definition including the same in memory of the voice-command recognition system 100.

Returning to FIG. 3B, as is indicated by the open and closed brackets “{” and “}” at lines 7 and 12 of the second voice command definition 3200, the voice command template section of the second voice command definition 3200 includes lines 8-11. Further, in the example illustrated in FIG. 3B, each variable template indicates a location of the variable “x” within the text of the template so as to facilitate a process of the command recognition module 140 extracting a value of variable “x” from the text of the recognized speech 132, in the event that the text of the recognized speech 132 is determined by the command recognition module 140 to correspond to one of the voice command templates defined by lines 8-11 of the second voice command definition 3200.

For example, using the voice command template at line 8 of the second voice command definition 3200 (“SET HEADING #x # DEGREES”) as an example, according to at least some example embodiments, once the command recognition module 140 determines that text in the recognized speech 132 matches the text of the voice command template, excluding variables (i.e., “SET HEADING” and “DEGREES”), the command recognition module 140 will use the location of the expression “#x #” relative to other terms within the voice command template at line 8 to determine which word or phrase within the text of the recognized speech 132 to interpret as identifying the value of the variable “x.” For example, if the recognized speech 132 identified by the speech recognition module 130 includes the text “set heading two degrees,” the command recognition module 140 would determine the value of the variable “x” to be “2,” and the avionics system command 144 that the command recognition module 140 would send to the avionics system module 150 for execution (i.e., in the event that the command recognition module 140 successfully completes the confirmation process discussed above with reference to FIGS. 1 and 3A) would be the command “TargetHeading” with the argument “2.”

FIG. 3C illustrates an example of a voice command definition corresponding to a target altitude setting command. Referring to FIG. 3C, a third voice command definition 3300 includes some features that are similar to features previously discussed above with reference to FIG. 3B. For example, as is discussed above with reference to FIG. 3B, the second voice command definition 3200 is an example of a voice command definition that defines, as an argument of an avionics system command, a variable (i.e., the variable “x”). Returning to FIG. 3C, the third voice command definition 3300 is an example of a voice command definition that expresses an argument of an avionics system command using a mathematical function. For example, as is illustrated in FIG. 3C, line 3 of the third voice command definition 3300 identifies the avionics system command “TargetAltitude,” and identifies, as an argument, the expression “#x=x/100 #,” which includes the mathematical function x=x/100. Further, as is illustrated by lines 8-19 of the third voice command definition 3300, each of the voice command templates within the voice command template section of the third voice command definition 3300 includes the variable “x.” Thus, according to at least some example embodiments, after the command recognition module 140 uses the location of the expression #x # within a voice command template to identify, from the text of the recognized speech 132, the value of the variable “x” (e.g., in the manner discussed above with reference to FIG. 3B), the command recognition module 140 will apply the identified value to the function x=x/100 in order to determine a final value of the argument of the command “TargetAltitude.”

For example, using the voice command template at line 8 of the third voice command definition 3300 (i.e., “SET ALTITUDE #x # FEET”) as an example, if the recognized speech 132 identified by the speech recognition module 130 includes the text “set altitude ten thousand feet,” the command recognition module 140 would first determine the value of the variable “x” to be “10,000.” Next, the command recognition module 140 would apply the value “10,000” to the function x=x/100, thereby dividing the value “10,000” by 100, and setting the result (i.e., 10,000/100=100) as the new value of the variable “x,” and thus, the value of the argument of the command “TargetAltitude.” Consequently, the avionics system command 144 that the command recognition module 140 will send to the avionics system module 150 for execution (i.e., in the event that the command recognition module 140 successfully completes the confirmation process discussed above with reference to FIGS. 1 and 3A) would be the command “TargetAltitude” with the argument “100”.

For the purpose of simplicity, FIG. 3C is described above with reference to an example in which the mathematical function (i.e., x=x/100) used to define an argument of an avionics system command includes only a single division operation. However, at least some example embodiments are not limited to this example. For example, according to at least some example embodiments, the mathematical function used to define an argument of an avionics system command may include other known mathematical operations (e.g., addition “+,” subtraction “−,” multiplication “*,” exponents “A,” etc.). Further, according to at least some example embodiments, the mathematical function used to define an argument of an avionics system command may include a combination of multiple mathematical operations, and may also include parenthetical notation (e.g., x=(100−x)*10).

FIG. 3D illustrates an example of a voice command definition corresponding to a command to level off and maintain a current speed, heading and altitude. As is illustrated in FIG. 3D, a fourth voice command definition 3400 is an example of a voice command definition that identifies more than one avionics system command. For example, line 5 identifies the command “TargetAirspeed” and the argument “IndicatedAirspeed.” According to at least some example embodiments, the term “IndicatedAirspeed” may be one of a plurality of identifiers which the avionics system module 150 interprets as corresponding to particular values, attributes or measurements tracked by the avionics system module 150. For example, the avionics system module 150 may interpret the identifier “IndicatedAirspeed” as referring to a current air speed indicated by the avionics system module 150. Accordingly, the avionics system module 150 may interpret the command TargetAirspeed with the argument IndicatedAirspeed as a command to set a target airspeed to the current airspeed (i.e., the current airspeed indicated by the avionics system module 150), thus ceasing acceleration or deceleration. Similarly, referring to line 6 of the fourth voice command definition 3400, the avionics system module 150 may interpret the term “AircraftHeading” as an identifier that refers to a current heading indicated by the avionics system module 150. Thus, the avionics system module 150 may interpret the command “TargetHeading” with the argument “AircraftHeading” as a command to set a target heading to the current heading (i.e., the current heading indicated by the avionics system module 150). Referring to line 7 of the fourth voice command definition 3400, the avionics system module 150 may interpret the command “VerticalSpeed” with the argument “0” as a command to set a target vertical speed to the value “0.”

Further, as is illustrated by lines 8-10 in FIG. 3D, the fourth voice command definition 3400 may include a voice command template, “STOP.” Consequently, the command recognition module 140 would respond to determining that the recognized speech 132 identified by the speech recognition module 130 includes the text “stop” which matches a voice command template included in the fourth voice command definition 3400 by sending all three of the commands identified by lines 5-7 of the fourth voice command definition 3400 to the avionics system module 150 for execution. Further, the command recognition module 140 may send the commands identified by lines 5-7 to the avionics system module 150 for execution while omitting the confirmation process because, as is illustrated by FIG. 3D, line 4 includes the confirmation omission indicator “URGENT.” Thus, according to at least some example embodiments, the command recognition module 140 may send a plurality of avionics system commands 144, together, to the avionics system module 150 for execution.

FIG. 3E illustrates an example of a voice command definition corresponding to a command to set an aircraft altitude to a current altitude. Referring to FIG. 3E, a fifth voice command definition 3500 includes some features that are similar to features previously discussed above with reference to FIGS. 3C and 3D. For example, as is discussed above with reference to FIG. 3C, the third voice command definition 3300 is an example of a voice command definition that defines an argument of an avionics system command using a mathematical function. Further, as is discussed above with reference to FIG. 3D, the fourth voice command definition 3400 is an example of a voice command definition that includes identifiers (e.g., IndicatedAirspeed and AircraftHeading), which the avionics system module 150 may interpret as referring to specific values, attributes, or measurements tracked by the avionics system module 150, as arguments for commands. Returning to FIG. 3E, the fifth voice command definition 3500 is an example of a voice command definition that defines an argument of an avionics system command using a mathematical function which includes, as one or more operands, one or more identifiers which the avionics system module 150 may interpret as referring to specific values, attributes, or measurements tracked by the avionics system module 150. For example, line 3 of the fifth voice command definition 3500 identifies, as an avionics system command, the command “TargetAltitude.” Further, line 3 of the fifth voice command definition 3500 identifies, as an argument of the command “TargetAltitude,” the mathematical function “CurrentAltitudePilot/100.” According to at least some example embodiments, the term “CurrentAltitudePilot” is an identifier that refers to a current altitude indicated by the avionics system module 150.

According to at least some example embodiments, if the command recognition module 140 determines to provide the command and argument defined by line 3 of the fifth voice command definition 3500 to the avionics system module 150 for execution, the command recognition module 140 obtains the current altitude indicated by the avionics system module 150 from the avionics system module 150, determines a final value of the argument by performing the indicated mathematical function (i.e., CurrentAltitudePilot/100), and sends the determined final value to the avionics system module 150 as the argument of the command “TargetAltitude.” Alternatively, according to at least some example embodiments, the command recognition module 140 sends the mathematical function “CurrentAltitudePilot/100” as the argument for the command TargetAltitude,” and the avionics system module 150 determines the final value of the argument by performing the mathematical function.

Further, as is illustrated by lines 5-12 of the voice command template section of the fifth voice command definition 3500, a user can define several different phrases as corresponding to the avionics system command indicated by line 3, thereby allowing the pilot 110 the flexibility to use more than one phrase as a voice command for executing the avionics system command. Additionally, the multiple voice command templates illustrated in FIG. 3E may represent a scenario in which multiple pilots use the voice-command recognition system 100 at different times, and the multiple pilots have different preferred phrases for executing the avionics system command indicated by line 3.

FIG. 3F illustrates an example of a voice command definition corresponding to a command to set a target airspeed. Referring to FIG. 3F, a sixth voice command definition 3600 includes the keyword “CALL” in line 3 followed by a function and a corresponding argument for the function. As is shown in line 3, the function is “setSpeed( )” and the argument is the variable “x.” According to at least some example embodiments, the function “setSpeed( )” may be a function for setting a target airspeed.

According to at least some example embodiments, the voice-command recognition system 100 interprets the keyword “CALL” as an indication to performing a function call by referring to a function (e.g., a routine or subroutine) which may be defined outside of the voice command definition in which the keyword “CALL” is present. For example, memory of the voice-command recognition system 100 (e.g., memory unit 256) may store one or more files including code and/or instructions defining one or more functions. Further, according to at least some example embodiments, in response to determining that a voice command definition includes the keyword CALL followed by the name of a function in a voice command definition, the command recognition module 140 may retrieve and execute the code and/or instructions defining the named function. Additionally, according to at least some example embodiments, when the name of the function is provided with one or more arguments for the named function, the command recognition module 140 may pass the one or more arguments to the named function (e.g., the command recognition module 140 may use the one or more arguments as inputs when executing the code and/or instructions defining the named function). Further, according to at least some example embodiments, the code and/or instructions defining the named function may identify one or more avionics system commands, and executing the code and/or instructions defining the named function may include the command recognition module 140 providing the one or more identified avionics system commands to the avionics system module 150 for execution by the avionics system module 150.

For example, according to at least some example embodiments, in the event that the command recognition module 140 determines that the recognized speech 132 identified by the speech recognition module 130 includes the text which matches a voice command template included in the sixth voice command definition 3600, and receives confirmation from the pilot 110, the command recognition module 140 may interpret line 3 of the sixth voice command definition 3600 (i.e., “CALL setSpeed( ), #x #”) as an indication to determine the value of the variable “x” from the recognized speech 132 (e.g., in the manner discussed above with reference to FIG. 3B), and pass the determined value of the variable “x” to the function setSpeed( ). Accordingly, the keyword “CALL” may be included within a voice command definition of a user-defined script in order to reference complex operations which may not be easily defined within a voice command definition of a user-defined script file.

According to at least some example embodiments, upon initialization of the voice-command recognition system 100 during the tokenization process discussed above with reference to FIG. 3A, the command recognition module 140 identifies the keyword ‘CALL’ and corresponding functions and arguments of the functions within voice command definitions, and the command recognition module 140 saves, in memory of the voice-command recognition system 100, information corresponding to the functions and arguments for each voice command definition that includes the keyword ‘CALL.’ Additionally, according to at least some example embodiments, the command recognition module 140 may retrieve definitions of the functions corresponding to the keyword ‘CALL’ (which may be located outside the user-defined script file(s) including the corresponding voice command definitions) and store the definitions in memory of the voice-command recognition system 100 during the tokenization process discussed above with reference to FIG. 3A.

Returning to FIG. 3F, the sixth voice command definition 3600 provides an example of defining a variable with two different ranges. For example, as is illustrated by lines 4 and 5 in FIG. 3F, the range of the variable “x” is defined as both 0-340 and 0.72-0.8 by using the expression “Range: 0. 0.340|0.72. 0.0.8.” In the example illustrated in FIG. 3F, two different ranges may be used because airspeed may be expressed in terms of knots (e.g., 0-340 knots) or as a Mach number (e.g., Mach 0.72-0.8). Further, as is illustrated in line 6, a type of the variable “x” is identified as “number.” According to at least some example embodiments, the variable type “number” includes both integers and floating point numbers.

FIG. 3G illustrates an example of a voice command definition corresponding to a command to zoom a navigation display in or out. As is illustrated in FIG. 3G, the contents of line 4 of the seventh voice command definition 3700 are “CALL navZoom( ),#direction #,#factor #.” As is indicated by the keyword “CALL” in line 4, navZoom( ) is a function which may be defined outside of the seventh voice command definition 3700. According to at least some example embodiments, navZoom( ) may be a function for causing the avionics system module 150 to change a zoom level of a navigation display, and may accept, as arguments, both a zoom direction “direction” and a zoom factor “factor.” As is shown by lines 5-10 of the seventh voice command definition 3700, the variable “direction,” which indicates a direction of the zoom level change, may have a value of “IN” or “OUT,” and the variable “factor,” which indicates a magnitude of the zoom level change, may have a value that is an integer between 1-5.

Consequently, in the event that the command recognition module 140 determines that the recognized speech 132 identified by the speech recognition module 130 includes text which matches a voice command template included in the seventh voice command definition 3700, the command recognition module 140 may interpret line 4 of the seventh voice command definition 3700 (i.e., “CALL navZoom( ),#direction #,#factor #”) as an indication to determine the values of the variables “direction” and “factor” from the recognized speech 132 (e.g., in the manner discussed above with reference to FIG. 3B), and pass the determined values of the variables “direction” and “factor” to the function navZoom( ) (e.g., in the manner discussed above with reference to FIG. 3F).

FIG. 4 is a flow chart illustrating an example method of operating the voice-command recognition system 100 to perform user-defined script-based voice-command recognition according to at least some example embodiments.

Referring to FIG. 4, in operation S305, the voice-command recognition system 100 (e.g., the speech recognition module 130) generates text from raw speech. For example, as is discussed above with reference to FIG. 1, the speech recognition module 130 may perform a speech-to-text function. For example, according to at least some example embodiments, in operation S305, the speech recognition module 130 receives raw speech 122 from the headset 120, recognizes words from the raw speech 122, and generates text corresponding to the recognized words as recognized speech 132. According to at least some example embodiments, the voice-command recognition system 100 (e.g. the speech recognition module 130) may begin evaluating audio input from the headset 120 as the raw speech 122 and converting the raw speech 122 into the recognized speech 132 in response to the pilot 110 initiating a speech-to-text (STT) operation (e.g., by pressing a voice-command button located on the headset 120, a sidestick or elsewhere). Further, according to at least some example embodiments, the voice-command recognition system 100 (e.g. the speech recognition module 130) may cease evaluating audio input from the headset 120 as the raw speech 122 and converting the raw speech 122 into the recognized speech 132 in response to the pilot 110 ending STT operation (e.g., by discontinuing the pressing of the voice-command button).

In operation S310, the voice-command recognition system 100 filters the text generated in operation S310. For example, in operation S310, the command recognition module 140 receives the recognized speech 132, and performs a filtering operation on the text within the recognized speech 132. Alternatively, the speech recognition module 130 may perform a filtering process on the words recognized by the speech recognition module and output text corresponding to the filtered words as recognized speech 132.

The filtering operation performed in operation S310 may include, for example, replacing words that sound like words included in voice command templates of the dictionary of the voice-command recognition system 100 with the corresponding words from the dictionary of the voice-command recognition system 100. According to at least some example embodiments, filtering may be performed in accordance with one or more user-defined filter files. According to at least some example embodiments, the one or more user-defined filter files are files (e.g., text files) that identify, for each of one or more words and/or phrases included in voice command templates of the dictionary, similar-sounding words and/or phrases that should be changed into the word and/or phrase from the voice command template.

Additionally, according to at least some example embodiments, the filtering operation performed in operation S310 may further include changing a format of text resulting from the speech-to-text function of the speech recognition module 130 (e.g., changing text to upper-case text, changing text to lower-case text, changing numerals into corresponding letters or vice versa, etc.).

In operation S315, the voice-command recognition system 100 (e.g., the command recognition module 140) determines whether text of the recognized speech 132, after the filtering of operation S310, matches syntax and/or a template included in the dictionary of the voice-command recognition system 100. For example, in operation S315, the command recognition module 140 may determine whether text of the recognized speech 132 corresponds to a voice command template included in one of the voice command definitions in a user-defined script file of the dictionary of the voice-command recognition system 100 (e.g., a voice command template included in one of the voice command definitions in a user-defined script file read by the voice-command recognition system 100 during the initialization of the voice-command recognition system 100, as is discussed above with reference to FIG. 3A). For example, as is discussed above with reference to FIG. 3A, according to at least some example embodiments, the command recognition module 140 will determine that text included in the recognized speech 132 corresponds to a voice command template when the text of the recognized speech 132 (excluding variables) matches the text of the voice command template (excluding variables).

Further, according to at least some example embodiments, for the purpose of comparing text of the recognized speech 132 to voice command templates, the command recognition module 140 may refer to versions of the voice command templates that were previously identified and stored in memory of the voice-command recognition system 100 by the command recognition module 140 during initialization of the voice-command recognition system 100, as is discussed above with reference to FIG. 3A.

In response to determining that the text of the recognized speech 132 (excluding variables) does not match text of any of the voice command templates of the dictionary (excluding variables), the voice-command recognition system 100 proceeds to operation S317.

In operation S317, the voice-command recognition system 100 (e.g., the command recognition module 140) outputs the message “invalid command.” For example, referring to FIG. 1, the command recognition module 140 may generate synthetic speech 142 to include the message “invalid command” as an audible message, and cause headset 120 to output the audible message by sending the audible message to the headset 120. According to at least some example embodiments, synthetic speech 142 is audible, machine-generated speech that is formed based on text. For example, according to at least some example embodiments, the command recognition module 140 may generate the text “invalid command,” generate speech by performing a text-to-speech (TTS) function on the generated text, and send the generated speech to the command recognition module 140 as the synthetic speech 142.

Further, according to at least some example embodiments, in operation S317, the message “invalid command” can be displayed visually to the pilot 110. For example, as is noted above with reference to FIG. 1, the voice-command recognition system 100 may include a display device (not illustrated). Further, according to at least some example embodiments, in operation S317, the command recognition module 140 may generate the message “invalid command” as visible text and cause the display device to display the visible message by sending the visible message to the display device. For example, in operation S317, the command recognition module 140 may cause the display device to display the visible message “invalid command” instead of, or in addition to, the command recognition module 140 causing the headset 120 output the audible message “invalid command.” Thus, in operation S317, the pilot 110 can hear, via the headset 120, and/or see, via the display device, that the voice-command recognition system 100 did not discern a valid command from the raw speech 122 received in operation S305.

According to at least some example embodiments, after operation S317, the method of FIG. 4 may end, for example, until the pilot initiates another STT operation in the manner discussed above with reference to operation S305.

Returning to operation S315, in response to determining that the text of the recognized speech 132 (excluding variables) matches text of a voice command templates of the dictionary (excluding variables), the voice-command recognition system 100 proceeds to operation S320.

In operation S320, the voice-command recognition system 100 (e.g., the command recognition module 140) determines whether one or more recognized avionics system commands include one or more variables. For example, in operation S320, the command recognition module may refer to information about voice command definitions and features of voice command definitions stored in memory of the voice-command recognition system 100 by the command recognition module 140 during the initialization of the voice-command recognition system 100, as is discussed above with reference to FIG. 3A. Further, based on the previously stored information, the command recognition module 140 may select the voice command definition that includes the matching voice command template determined operation S315, and determine, as the recognized one or more avionics system commands, the one or more avionics system commands identified by the selected voice command definition. Further, the command recognition module 140 may determine any variables included in the recognized one or more avionics system commands (e.g., as command arguments), and determine any attributes (e.g., type, range, etc.) of the variables.

If, in operation S320, the command recognition module 140 determines that the recognized one or more avionics system commands include one or more variables, the voice-command recognition system 100 proceeds to operation S325. If, in operation S320, the command recognition module 140 determines that the recognized one or more avionics system commands do not include one or more variables, the voice-command recognition system 100 skips operation S325 and proceeds to operation S330. Operation S330 will be discussed below after operations S325 and S327.

Referring to operation S325, in operation S325, the command recognition module 140 determines whether values of the one or more variables of the recognized one or more avionics system commands determined in operation S320 are in range. For example, in operation S325, the voice-command recognition system 100 (e.g., the command recognition module 140) may identify values for the variable(s) determined in operation S320 from within the text of the recognized speech 132 based on the location of the variable(s) within the matching voice command template, for example, in the same manner discussed above with reference to FIG. 3B and the locations of the expression “#x #” in the voice command templates of lines 8-11 of the second voice command definition 3200. Next, according to at least some example embodiments, the command recognition module 140 compares the determined values of the one or more variables to the ranges determined in operation S320 for the one or more variables.

If, in operation S325, the command recognition module 140 determines that the values of one or more variables of the recognized one or more avionics system commands determined in operation S320 are not within their corresponding ranges, the voice-command recognition system 100 proceeds to operation S327.

In operation S327, the voice-command recognition system 100 may operate in the same manner discussed above with reference to operation S317, with the exception that the message output by the command recognition module 140 to the display device and/or headset 120 is “value out of range.” For example, in operation S327, the command recognition module 140 may cause the display device to display the visible message “value out of range” and/or cause the headset 120 output the audible message “value out of range.”

According to at least some example embodiments, after operation S327, the method of FIG. 4 may end, for example, until the pilot initiates another STT operation in the manner discussed above with reference to operation S305.

If, in operation S325, the command recognition module 140 determines that the values of the one or more variables of the recognized one or more avionics system commands determined in operation S320 are within their corresponding ranges, the voice-command recognition system 100 proceeds to operation S330.

In operation S330, the command recognition module 140 determines whether or not to perform a confirmation process. For example, the command recognition module 140 may refer to information about voice command definitions and features of voice command definitions stored in memory of the voice-command recognition system 100 by the command recognition module 140 during the initialization of the voice-command recognition system 100 to determine whether the voice command definition that identifies the recognized one or more avionics system commands contains a confirmation omission indicator (e.g., “URGENT”).

If, in operation S340, the command recognition module 140 determines that the voice command definition that identifies the recognized one or more avionics system commands includes a confirmation omission indicator, the voice-command recognition system 100 proceeds to operation S345 without performing the confirmation process of operations S335 and S340. The confirmation process of operations S335 and S340 will be discussed below after operations S345 and S350.

In operation S345, the command recognition module 140 provides the recognized one or more avionics system commands determined in operation S320 to the avionics system module 150 for execution by the avionics system module 150. According to at least some example embodiments, when the avionics system module 150 and the command recognition module 140 are implemented by separate devices, the command recognition module 140 may send the recognized one or more avionics system commands to the avionics system module 150. For example, according to at least some example embodiments, the command recognition module 140 may include the recognized one or more avionics system commands in one or more TCP/IP data packets, and transmit the TCP/IP data packets to the avionics system module 150. Further, while TCP/IP are discussed as examples of communications protocols, according to at least some example embodiments, the command recognition module 140 may send the recognized one or more avionics system commands to the avionics system module 150 using other communication protocols. For example, the command recognition module 140 may transmit the recognized one or more avionics system commands to the avionics system module 150 as data following an Aeronautical Radio, Incorporated (ARINC) protocol (e.g., ARINC 429, ARIC 629 and/or ARINC 664). After operation S345, the voice-command recognition system 100 proceeds to operation S350.

According to at least some example embodiments, in operation S350 the command recognition module 140 sends, to the headset 120, an audible indication that the recognized one or more avionics system commands have been sent to the avionics system module 150 for execution by the avionics system module 150. Examples of the audible indication that is generated by the command recognition module 140 and sent to the avionics system module 150 in operation S350 include, but are not limited to, a beep, a chime, and synthetic speech including one or more names of the recognized one or more avionics system commands. According to at least some example embodiments, the command recognition module 140 may perform a TTS operation to generate the synthetic speech corresponding to one or more names of the recognized one or more avionics system commands.

Returning to operation S340, if, in operation S340, the command recognition module 140 determines that the voice command definition that identifies the recognized one or more avionics system commands does not include a confirmation omission indicator, the voice-command recognition system 100 performs the confirmation process of operations S335 and S340.

For example, in operation S335, the command recognition module 140 generates an audible request for confirmation of one or more of the recognized avionics system commands in the form of synthetic speech 142 (e.g., by performing a TTS operation); and sends the synthetic speech 142 to headset 120. The headset 120 provides the confirmation request to the pilot 110 as the command confirmation 124 illustrated in FIG. 1. According to at least some example embodiments, the synthetic speech 142 generated in operation S335 includes one or more names of the recognized one or more avionics system commands determined in operation S320. Further, in operation S335, the command recognition module 140 may generate a visible request for confirmation of the one or more of the recognized avionics system commands and cause the display device (not illustrated) included in the voice-command recognition system 100 to display the visible request, for example, in the form of text.

After operation S335, the voice-command recognition system proceeds to operation S340. In operation S340, the command recognition module 140 postpones the provision of the recognized one or more avionics system commands (e.g., one or more of the avionics system commands 144 of FIG. 1) to the avionics system module 150 for execution until receiving an indication that the pilot 110 has confirmed the recognized one or more avionics system commands. As is illustrated in FIG. 4, once the confirmation of the recognized one or more avionics system commands is received in operation S340, the voice-command recognition system 100 proceeds to operations S345 and S350, which are described above.

Further, according to at least some example embodiments, when, in operation S340, the command recognition module 140 detects no user response, the command recognition module 140 proceeds to operation S337 and determines whether or not a timeout period has expired. According to at least some example embodiments, the timeout period begins upon the completion of operation S335. As is illustrated in FIG. 4, in response to determining that the timeout period has not expired, the command recognition module 140 returns to operation S340. Further, in response to determining that the timeout period has expired, the command recognition module 140 cancels the recognized one or more avionics system commands.

Thus, as is illustrated by FIG. 4, operation S337 and S340 are iteratively performed by the command recognition module until the timeout period expires, a command confirmation is received from the pilot 110, or a command cancellation request is received from the pilot 110. For example, as is illustrated by FIG. 4, according to at least some example embodiments, if, during the iterative performance of operations S337 and S340, the command recognition module 140 does not receive confirmation of the recognized one or more avionics system commands from the pilot 110 within a reference amount of time (e.g., before expiration of the timeout period), or the pilot 110 responds to the confirmation request with a cancellation request, the command recognition module 140 cancels the recognized one or more avionics system commands. According to at least some example embodiments, when the command recognition module 140 cancels the recognized one or more avionics system commands, the method of FIG. 4 may end, for example, until the pilot 110 initiates another STT operation in the manner discussed above with reference to operation S305.

Operation S330 is described above with reference to an example in which the command recognition module 140 performs the confirmation process of operations S335, S337 and S340 by default and omits the confirmation process in response to determining the presence of a confirmation omission indicator (e.g., “URGENT”) in the voice command definition that identifies the recognized one or more avionics system commands determined in operation S320. However, at least some example embodiments are not limited to this example. For example, according to at least some example embodiments, in operation S330, the command recognition module 140 may omit the confirmation process of operations S335 and S340 by default and perform the confirmation process in response to determining the presence of a confirmation performance indicator (e.g., “NOT_URGENT,” “CONFIRM,” “CONF,” “CONF_1,” etc.) in the voice command definition that identifies the recognized one or more avionics system commands determined in operation S320.

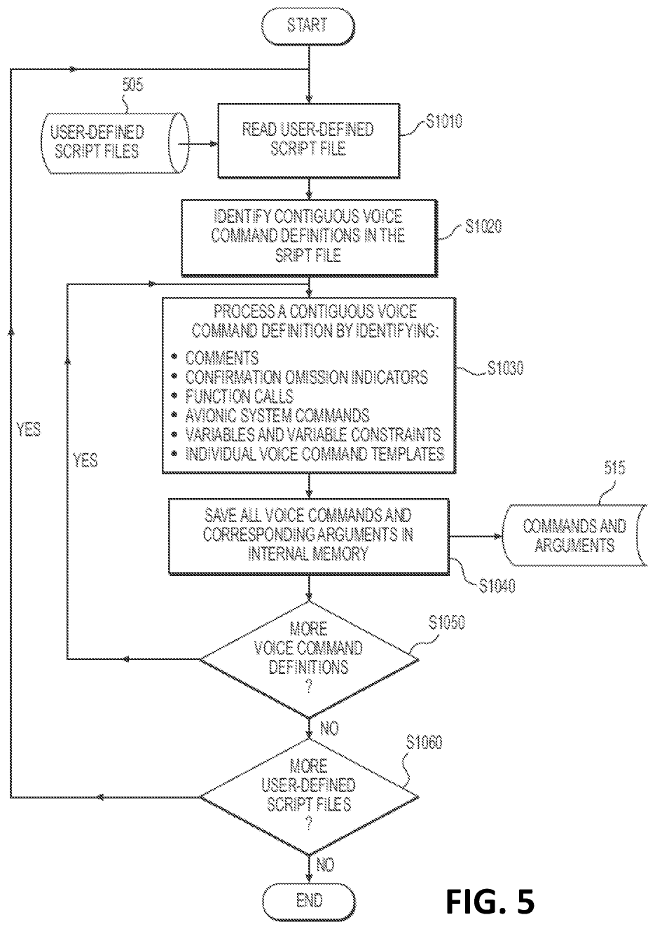

An example initialization process of the voice-command recognition system 100 will now be discussed with reference to FIG. 5.

FIG. 5 is a flow chart illustrating an example initialization method of a voice-command recognition system according to at least some example embodiments.

According to at least some example embodiments, the voice-command recognition system 100 may perform the operations included in the initialization method of FIG. 5 prior to performing the operations of the method illustrated in FIG. 4. Further, according to at least some example embodiments, multiple types of user-defined files may be read by the voice-command recognition system 100 during the initialization method of FIG. 5. For example, the voice-command recognition system 100 may read the user-defined filter files discussed above with reference to operation S310 of FIG. 4, the user-defined confirmation omission indicator configuration file discussed above with reference to FIG. 3A, and the user-defined script files which include the voice command definitions that form some or all of the dictionary of the voice-command recognition system 100 as is discussed above with reference to FIGS. 3A-3G. However, for the purpose of simplicity, the initialization procedures illustrated in FIG. 5 are those associated with the user-defined script files which include the voice command definitions.

Referring to FIG. 5, in operation S1010, the voice-command recognition system 100 (e.g., the command recognition module 140) may read a user-defined script file from user-defined script file storage 505. According to at least some example embodiments, the user-defined script file storage 505 may store one or more user-defined script files. According to at least some example embodiments, the user-defined script file storage 505 is included in the voice-command recognition system 100 and may be embodied by, for example, the memory unit 256 of FIG. 2. According to at least some example embodiments, a user may store user-defined script files in a desired or, alternatively, predefined directory (e.g., within the memory unit 256). Further, according to at least some example embodiments, user-defined script files that are to be read by the command recognition module 140 may have a desired or, alternatively, predefined extension (e.g., “.dvi”) which allows the voice-command recognition system 100 to recognize the user-defined script files. After operation S1010, the voice-command recognition system 100 proceeds to operation S1020.

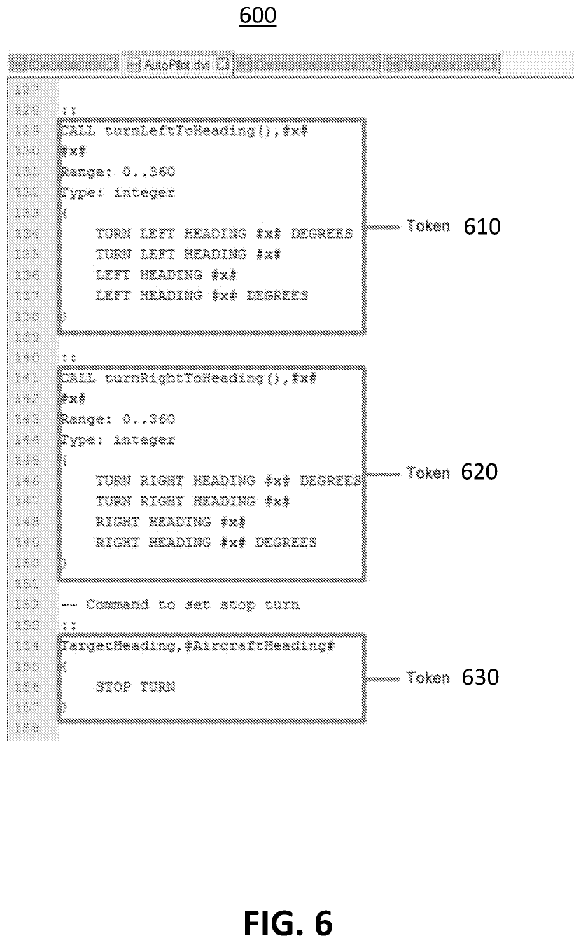

In operation S1020, the voice-command recognition system 100 (e.g., the command recognition module 140) identifies contiguous voice command definitions in the read user-defined script file. For example, according to at least some example embodiments, in operation S1020, the command recognition module 140 may perform tokenization on the read user-defined script files in order to identify the separate voice command definitions included in the read user-defined script file. The tokenization performed in operation S1020 will now be discussed in greater detail below with reference to FIG. 6.

FIG. 6 illustrates an example of voice command definition tokenization. For example, FIG. 6 shows user-defined script 600. In operation S1020, the voice-command recognition system 100 (e.g., the command recognition module 140) reads the text of the user-defined script 600, for example, as a single text string. Further, the command recognition module 140 may tokenize the single text string on the basis of the special characters “::” shown at lines 128, 140 and 153 of the user-defined script 600 as illustrated in FIG. 6. Consequently, as a result of tokenizing single string corresponding to the user-defined script 600 on the basis of the special characters “::”, the command recognition module 140 creates three tokens: first token 610, second token 620 and third token 630. According to at least some example embodiments, the first through third tokens 610-630 are strings into which the single string corresponding to the user-defined script 600 has been split as a result of the tokenization. After tokenizing the user-defined script 600, the command recognition module 140 may store each of the resulting tokens. As is illustrated in FIG. 6, the first, second and third tokens 610, 620 and 630 correspond, respectively, to first, second and third contiguous voice command definitions included in the user-defined script 600. Thus, by generating the first through third tokens 610-630, the command recognition module 140 identifies the three contiguous voice command definitions included in the user-defined script 600 in operation S1020. According to at least some example embodiments, the command recognition module 140 stores the first through third tokens 610-630 (e.g., in memory unit 256 of FIG. 2). After operation S1020, the voice-command recognition system 100 proceeds to operation S1030.

In operation S1030, the voice-command recognition system 100 (e.g., the command recognition module 140) selects one of the contiguous voice command definitions identified in operation S1020, and processes the selected voice command definition by identifying features of the selected voice command definition. As is discussed above with reference to FIGS. 3A-3G, features of a voice command definition include, for example, confirmation omission indicators, function calls (e.g., indicated by the keyword “CALL”), avionics system commands, variables and variable constraints, and individual voice command templates. Each of the above-referenced features is expressed, in voice command definitions, in accordance with a defined format as is discussed above with reference to FIGS. 3A-3G. Thus, in operation S1030, the processing of the selected voice command definition by the command recognition module 140 includes performing a tokenization process on the selected voice command definition on the basis of the defined formats of the features included in the selected voice command definition. As a result of the tokenization process, the command recognition module 140 generates tokens corresponding to the features of the selected voice command definition. Thus, by generating the tokens corresponding to the features of the selected voice command definition, the command recognition module 140 identifies the features of the selected voice command definition in operation S1030. After operation S1030, the voice-command recognition system 100 proceeds to operation S1040.

In operation S1040, the voice-command recognition system 100 (e.g., the command recognition module 140) saves any or all of the features of the selected voice command definition which were identified by the command recognition module 140 as a result of processing the selected voice command definition in operation S1030. The identified features of the selected voice command definition may be saved, for example, in internal storage (e.g., in memory unit 256 of FIG. 2).

For example, as is illustrated in FIG. 5, the command recognition module 140 may store commands and arguments 515. For example, commands and arguments 515 may include avionics system commands and/or function calls (i.e., the functions following the keyword CALL) of the selected voice command definition and any arguments defined by the selected voice command definition as being associated with the avionics system commands and/or function calls. Further, when an avionics command and/or function call includes one or more variables (e.g., as arguments), the stored commands and arguments 515 may further include storing the variables as well as any corresponding variable attributes (e.g., type, range, etc.) defined by the selected voice command definition. According to at least some example embodiments, operation S1040 further includes storing an indication of whether or not the selected voice command definition includes a confirmation omission indicator, and storing the voice command template(s) included in the selected voice command definition.

In operation S1050, the command recognition module 140 determines whether the user-defined script read in operation S1010 includes any unprocessed voice command definitions. If so, the command recognition module 140 performs operation S1030 with respect to a next unprocessed voice command definition. Accordingly, operations S1030 and S1040 are performed iteratively for each voice command definition included in the user-defined script read in operation S1010.

According to at least some example embodiments, due to operations S1030, S1040 and S1050 of the initialization method of FIG. 5, the command recognition module 140 stores, for each voice command definition in the user-defined script file read during operation S1010, at least the commands and arguments 515 of the voice command definition, an indication of whether or not the voice command definition includes a confirmation omission indicator, and the voice command template(s) of the selected voice command definition, in correspondence with each other, prior to the performance of the subsequent voice-command recognition method of FIG. 4. Consequently, the aforementioned voice command definition features can be quickly identified, retrieved from internal storage, and used (e.g., by the command recognition module 140) during the performance of the voice-command recognition method of FIG. 4.

Returning to operation S1050, in response to the command recognition module 140 determining that the user-defined script file read in operation S1010 includes no unread voice command definitions, the command recognition module 140 proceeds to operation S1060.

In operation S1060, the command recognition module determines whether the user-defined script files storage 505 includes any unread user-defined script files. In response to the command recognition module 140 determining that one or more unread user-defined script files exist in the user-defined script files storage 505, the command recognition module 140 returns to operation S1010 and reads a next unread user-defined script file from the user-defined script files storage 505. In response to the command recognition module 140 determining that no unread user-defined script files exist in the user-defined script files storage 505, the initialization method of FIG. 5 ends.

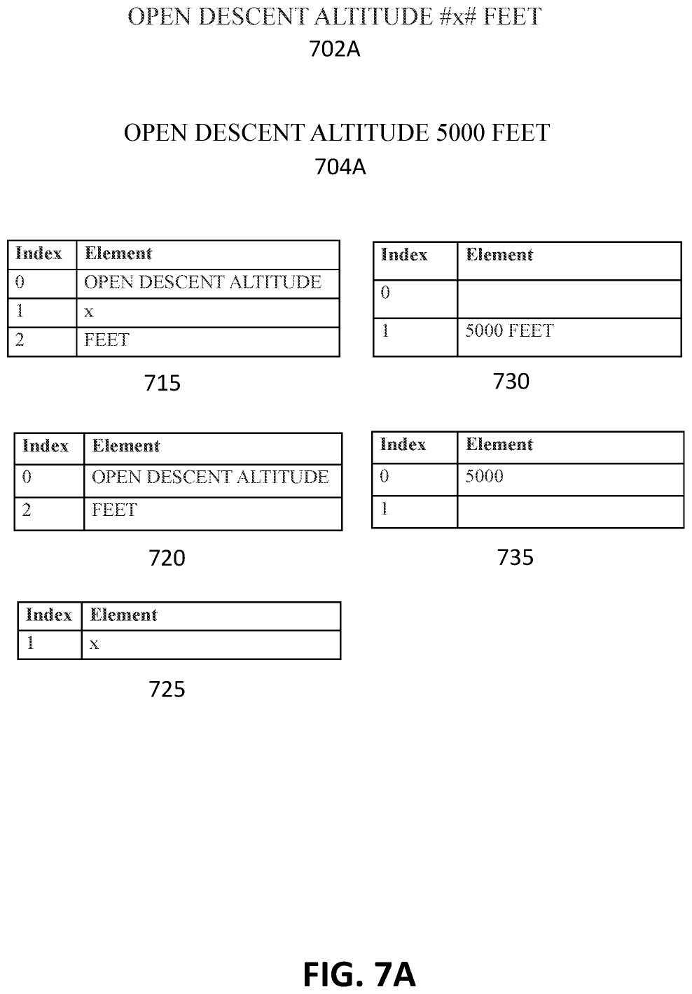

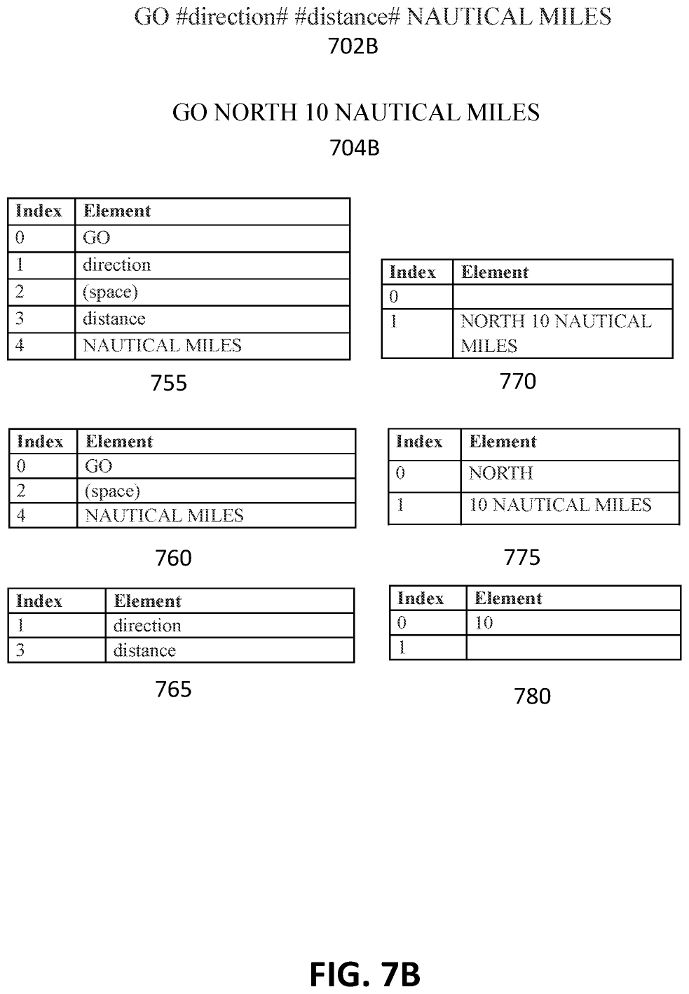

Examples of handling variables in voice commands according to at least some example embodiments will now be discussed in greater detail below with reference to FIGS. 7A and 7B.

FIGS. 7A and 7B are figures for facilitating the explanation of example methods of handling variables in voice command templates according to at least some example embodiments. Examples 1 and 2 will now be discussed in greater detail below. In each of Examples 1 and 2, processes that may be performed by the command recognition module 140 when identifying voice command templates (e.g., operation S1030 in FIG. 5) and processes that may be performed by the command recognition module 140 when determining whether recognized speech 132 matches a voice command template (e.g., operations S320 and/or S325 in FIG. 4) are discussed. Each of Examples 1 and 2 will be explained with respect to an example template string and an example input string. Each example template string represents a string (e.g., a text string) that corresponds to text of an individual voice command template included in a voice command definition and may be stored by the command recognition module 140, for example, when the command recognition module 140 identifies the individual voice command template (e.g., during operation S1030 in FIG. 5). Each example input string represents a string (e.g., a text string) corresponding to text that is output by the speech recognition module 130 as recognized speech 132 and received by the command recognition module 140 (e.g., during operation S305 and/or S310 in FIG. 4).

### Example 1

As is illustrated in FIG. 7A, the template string and input string for Example 1 are first template string 702A (“OPEN DESCENT ALTITUDE #x # FEET”) and first input string 704A (“OPEN DESCENT ALTITUDE 5000 FEET”).

According to at least some example embodiments, when the command recognition module 140 generates the first template string 702A corresponding to a voice command template of a voice command definition (e.g., in operation S1030 of FIG. 5 as a result of performing tokenization on an individual voice command definition), the command recognition module 140 may perform a further tokenization process on the first template string 702A in order to identify any variables included in the first template string 702A. For example, as is discussed above with reference to FIG. 3B, the command recognition module 140 interprets a term or value enclosed by two instances of the character “#” as a variable. Accordingly, in order to identify any variables in the first template string 702A, the command recognition module 140 may tokenize the first template string 702A based on the character “#” and store the resulting substrings as first template substring array 715.

According to at least some example embodiments, any elements of the first template substring array 715 with even indices (i.e., first even template substrings 720) contain substrings that must be present in the input string for a match, and any elements of the first template substring array 715 with odd indices (i.e., first odd template substrings 725) contain variable names. Thus, in order for input text to match the voice command template represented by the first template string 702A, the input text must include the substrings “OPEN DESCENT ALTITUDE” and “FEET,” as is shown by the first even template substrings 720. Further, the voice command template represented by the first template string 702A includes the variable “x,” as is shown by the first odd template substrings 725. According to at least some example embodiments, the first template substring array 715 may be generated and stored by the command recognition module 140 during the initialization method illustrated in FIG. 5. Accordingly, the first template substring array 715 will be available for use by the command recognition module 140 during the voice-command recognition method illustrated in FIG. 4, as will now be discussed in greater detail below.

According to at least some example embodiments, when the command recognition module 140 determines whether recognized speech 132 includes text/syntax that matches one of the voice command templates included in the dictionary of the voice-command recognition system 100 (e.g., operation S315 of FIG. 4), the command recognition module 140 may do so by comparing the recognized speech 132 (i.e., first input string 704A) to non-variable portions of a voice command template (i.e., the first even template substrings 720). In the example shown in FIG. 7A, the command recognition module 140 will determine that the recognized speech 132 (i.e., first input string 704A) matches a voice command template (i.e., the first template string 702A) because the first input string 704A (“OPEN DESCENT ALTITUDE 5000 FEET”) includes each element in the first even template substrings 720 (i.e., “OPEN DESCENT ALTITUDE” and “FEET”).

According to at least some example embodiments, after the command recognition module 140 determines that the recognized speech 132 includes text/syntax that matches one of the voice command templates, the command recognition module 140 determines (e.g., during operation S320 in FIG. 4) whether the recognized speech 132 includes variables by performing a tokenization process on the recognized speech 132 (i.e., first input string 704A).

For example, on a match, the command recognition module 140 may tokenize the first input string 704A with the matching substrings (e.g., on the first occurrence only), and push the first element of the resulting substring array onto a stack that stores the values of the variables. For example, first, the command recognition module 140 may tokenize the first input string 704A based on the first element (i.e., “OPEN DESCENT ALTITUDE”) of the first even template substrings 720, thus resulting in first input substring 730.

Next, the command recognition module 140 may tokenize element 1 of the first input substring 730 based on the second element (i.e., “FEET”) of the first even template substrings 720, thus resulting in second input substring 735. The command recognition module 140 may determine the first element (i.e., “5000”) of the second input substring 735 to be the value of the first variable (i.e., “x”) included in the first odd template substrings 725. Accordingly, the command recognition module 140 identifies the value “5000” from the recognized speech 132 as the value of the variable “x” from the voice command template that matches the recognized speech 132. A second example, Example 2, will now be discussed below.

### Example 2

As is illustrated in FIG. 7B, the template string and input string for Example 2 are second template string 702B (“GO #direction # #distance # NAUTICAL MILES”) and second input string 704N (“GO NORTH 10 NAUTICAL MILES”).

According to at least some example embodiments, when the command recognition module 140 generates the second template string 702B corresponding to a voice command template of a voice command definition (e.g., in operation S1030 of FIG. 5 as a result of performing tokenization on an individual voice command definition), the command recognition module 140 may perform a further tokenization process on the second template string 702B in order to identify any variables included in the second template string 702B. For example, in order to identify any variables in the second template string 702B, the command recognition module 140 may tokenize the second template string 702B based on the character “#” and store the resulting substrings as second template substring array 755.

According to at least some example embodiments, any elements of the second template substring array 755 with even indices (i.e., second even template substrings 760) contain substrings that must be present in the input string for a match, and any elements of the second template substring array 755 with odd indices (i.e., second odd template substrings 765) contain variable names. Thus, in order for input text to match the voice command template represented by the second template string 702B, the input text must include the substrings “GO,” (space), and “NAUTICAL MILES,” as is shown by the second even template substrings 760. Further, the voice command template represented by the second template string 702B includes the variables “direction” and “distance” as is shown by the second odd template substrings 765. According to at least some example embodiments, the second template substring array 755 may be generated and stored by the command recognition module 140 during the initialization method illustrated in FIG. 5. Accordingly, the second template substring array 755 will be available for use by the command recognition module 140 during the voice-command recognition method illustrated in FIG. 4, as will now be discussed in greater detail below.

According to at least some example embodiments, when the command recognition module 140 determines whether recognized speech 132 includes text/syntax that matches one of the voice command templates included in the dictionary of the voice-command recognition system 100 (e.g., operation S315 of FIG. 4), the command recognition module 140 may do so by comparing the recognized speech 132 (i.e., second input string 704B) to non-variable portions of a voice command template (i.e., the second even template substrings 760). In the example shown in FIG. 7B, the command recognition module 140 will determine that the recognized speech 132 (i.e., second input string 704B) matches a voice command template (i.e., the second template string 702B) because the second input string 704B (i.e., “GO NORTH 10 NAUTICAL MILES”) includes each element in the second even template substrings 760 (i.e., “GO,” (space) and “NAUTICAL MILES”).

According to at least some example embodiments, after the command recognition module 140 determines that the recognized speech 132 includes text/syntax that matches one of the voice command templates, the command recognition module 140 determines (e.g., during operation S320 in FIG. 4) whether the recognized speech 132 includes variables by performing a tokenization process on the recognized speech 132 (i.e., second input string 704B).

For example, on a match, the command recognition module 140 may tokenize the second input string 704B with the matching substrings (e.g., on the first occurrence only), and push first element of the resulting substring array onto a stack that stores the values of the variables. For example, first, the command recognition module 140 may tokenize the second input string 704B based on the first element (i.e., “GO”) of the second even template substrings 760, thus resulting in third input substring 770.

Next, the command recognition module 140 may tokenize element 1 of the third input substring 770 based on the second element (i.e., (space)) of the second even template substrings 760, thus resulting in fourth input substring 775. The command recognition module 140 may determine the first element (i.e., “NORTH”) of the fourth input substring 775 to be the value of the first variable (i.e., “direction”) included in the second odd template substrings 765.

Next, the command recognition module 140 may tokenize element 1 of the fourth input substring 775 based on the third element (i.e., “NAUTICAL MILES”) of the second even template substrings 760, thus resulting in fifth input substring 780. The command recognition module 140 may determine the first element (i.e., “10”) of the fifth input substring 780 to be the value of the second variable (i.e., “distance”) included in the second odd template substrings 765.

Accordingly, the command recognition module 140 identifies the values “NORTH” and “10” from the recognized speech 132 as the values, respectively, of the variables “direction” and “distance” from the voice command template that matches the recognized speech 132.

Further, while the user-defined script-based voice-command recognition method, initialization method and voice-command recognition system 100 discussed above with reference to FIGS. 1-7B are described as being applied to avionics systems, the user-defined script-based voice-command recognition method, initialization method and voice-command recognition system 100 are not limited to avionics systems. For example, the user-defined script-based voice-command recognition method, initialization method and voice-command recognition system 100 may be applied to other systems that can receive and execute commands.

Example embodiments being thus described, it will be obvious that embodiments may be varied in many ways. Such variations are not to be regarded as a departure from example embodiments, and all such modifications are intended to be included within the scope of example embodiments.

What is claimed:

1. A method of recognizing at least one avionics system command from a voice command, the method comprising:
receiving a plurality of voice command definitions,
each voice command definition identifying at least one avionics system command and identifying at least one voice command template that is mapped to the at least one avionics system command;
receiving the voice command as raw speech;
generating recognized speech by converting the raw speech into text;
determining a voice command template that corresponds to the recognized speech;
selecting a voice command definition, from among the plurality of voice command definitions, that identifies the determined voice command template;
determining, as the at least one recognized avionics system command, the at least one avionics system command identified by the selected voice command definition; and
providing the at least one recognized avionics system command to a avionics system for execution.

2. The method of claim 1, further comprising:
determining whether the selected voice command definition includes a confirmation omission indicator; and
in response to determining that the selected voice command definition does not include the confirmation omission indicator, performing a confirmation process,
the confirmation process including,
generating a confirmation request,
receiving a response to the confirmation request, and
postponing the providing of the at least one recognized avionics system command to the avionics system until after receiving the response to the confirmation request.

3. The method of claim 1, further comprising:
determining whether the selected voice command definition includes a confirmation performance indicator; and
in response to determining that the selected voice command definition includes the confirmation performance indicator, performing a confirmation process,
the confirmation process including,
generating a confirmation request,
receiving a response to the confirmation request, and
postponing the providing of the at least one recognized avionics system command to the avionics system until after receiving the response to the confirmation request.

4. The method of claim 1, wherein the receiving of the plurality of voice command definitions comprises:
receiving one or more script files; and
reading the plurality of voice command definitions from the one or more script files.

5. The method of claim 1, wherein the at least one avionics system command is at least one command defined by a specification of the avionics system.

6. The method of claim 5 further comprising:
executing, by the avionics system, the avionics system command.

7. The method of claim 5, wherein the avionics system is an avionics system of a flight simulator.

8. The method of claim 5, wherein the avionics system is an avionics system of an aircraft.

9. The method of claim 5, wherein,
the plurality of voice command definitions includes a first voice command definition,
the at least one voice command template identified by the first voice command definition is a plurality of voice command templates, and
the plurality of voice commands templates are mapped, by the first voice command definition, to the at least one avionics system command identified by the first voice command definition such that,
in response to any one of the plurality of voice command templates identified by the first voice command definition being determined to correspond to the recognized speech, the at least one avionics system command identified by the first voice command definition is provided to the avionics system as the at least one recognized avionics system command.

10. The method of claim 5, wherein,
the plurality of voice command definitions includes a first voice command definition,
the at least one avionics system command identified by the first voice command definition is a plurality of avionics system commands, and
the at least one voice command template identified by the first voice command definition is mapped, by the first voice command definition, to the plurality of avionics system commands such that,
in response to the at least one voice command template identified by the first voice command definition being determined to correspond to the recognized speech, the plurality of avionics system commands are provided to the avionics system as the at least one recognized avionics system command.

11. An apparatus for recognizing at least one avionics system command from a voice command, the apparatus comprising:
memory storing computer-executable instructions; and
one or more processors configured to execute the computer-executable instructions such that the one or more processors are configured to perform operations including,
receiving a plurality of voice command definitions,
each voice command definition identifying at least one avionics system command and identifying at least one voice command template that is mapped to the at least one avionics system command,
receiving the voice command as raw speech,
generating recognized speech by converting the raw speech into text,
determining a voice command template that corresponds to the recognized speech,
selecting a voice command definition, from among the plurality of voice command definitions, that identifies the determined voice command template,
determining, as the at least one recognized avionics system command, the at least one avionics system command identified by the selected voice command definition, and
providing the at least one recognized avionics system command to a avionics system for execution.

12. The apparatus of claim 11, wherein the one or more processors are further configured to execute the computer-executable instructions such that the one or more processors are configured to,
determine whether the selected voice command definition includes a confirmation omission indicator, and
in response to determining that the selected voice command definition does not include the confirmation omission indicator, perform a confirmation process,
the confirmation process including,
generating a confirmation request,
receiving a response to the confirmation request, and
postponing the providing of the at least one recognized avionics system command to the avionics system until after receiving the response to the confirmation request.

13. The apparatus of claim 11, wherein the one or more processors are further configured to execute the computer-executable instructions such that the one or more processors are configured to,
determine whether the selected voice command definition includes a confirmation performance indicator; and
in response to determining that the selected voice command definition includes the confirmation performance indicator, perform a confirmation process,
the confirmation process including,
generating a confirmation request,
receiving a response to the confirmation request, and
postponing the providing of the at least one recognized avionics system command to the avionics system until after receiving the response to the confirmation request.

14. The apparatus of claim 11, wherein the one or more processors are further configured to execute the computer-executable instructions such that the receiving of the plurality of voice command definitions comprises:
receiving one or more script files; and
reading the plurality of voice command definitions from the one or more script files.

15. The apparatus of claim 11, wherein the one or more processors are further configured to execute the computer-executable instructions such that the at least one avionics system command is at least one command defined by a specification of the avionics system.

16. The apparatus of claim 15 wherein the one or more processors are further configured to execute the computer-executable instructions such that the one or more processors are configured to cause the avionics system to execute the avionics system command.

17. The apparatus of claim 15, wherein the avionics system is an avionics system of a flight simulator.

18. The apparatus of claim 15, wherein the avionics system is an avionics system of an aircraft.

19. The apparatus of claim 15, wherein the one or more processors are further configured to execute the computer-executable instructions such that,
the plurality of voice command definitions includes a first voice command definition,
the at least one voice command template identified by the first voice command definition is a plurality of voice command templates, and
the plurality of voice commands templates are mapped, by the first voice command definition, to the at least one avionics system command identified by the first voice command definition such that,
in response to the one or more processors determining that any one of the plurality of voice command templates identified by the first voice command definition to corresponds to the recognized speech, the one or more processors provide the at least one avionics system command identified by the first voice command definition to the avionics system as the at least one recognized avionics system command.

20. The apparatus of claim 15, wherein the one or more processors are further configured to execute the computer-executable instructions such that,
the plurality of voice command definitions includes a first voice command definition,
the at least one avionics system command identified by the first voice command definition is a plurality of avionics system commands, and
the at least one voice command template identified by the first voice command definition is mapped, by the first voice command definition, to the plurality of avionics system commands such that,
in response to the one or more processors determining that the at least one voice command template identified by the first voice command definition corresponds to the recognized speech, the one or more processors provide the plurality of avionics system commands to the avionics system as the at least one recognized avionics system command.
